(19) United States
(12) Patent Application Publication
(10) Pub. No.: US 2007/0158445 A1
(43) Pub. Date: Jul. 12, 2007

(54) Secondary heating /cooling system, with thermal separation of sections

(76) Inventor: Boris Jovan Gorsevski, Aurora, CO (US)

Correspondence Address: Boris Jovan Gorsevski, 2230 47th st. N.W., Washington, DC, 20007, US

(21) Appl. No.: 11/330,505

(22) Filed: Jan. 12, 2006

(51) Int. Cl. B60H 1/00

(52) U.S. Cl. 237/2 A

(57) ABSTRACT

The secondary heating/cooling system, with sections of the building separation, is invention which unable energy conservation, by maintaining desire temperature in one section of the building and living the other section unheated/un cooled, during could or hot periods of the year, when energy demand is higher, or owner of the building has limited budget for heating or cooling.

### BACKGROUND OF THE INVENTION

This invention relates to design and calculation practices for central heating/cooling buildings in conjunction with remodeling work.

### BRIEF SUMMARY OF THE INVENTION

According to the invention, the above object is achieved by providing possibilities for separation of minimum two sections in a new or existing building, which one section shall be heated or cooled at desire temperature and the other section remain to level below or above the desire temperature. Beside primary central heating/cooling system for all building, one section is thermal separated from rest of the building and is equipped with secondary heating/cooling system, sufficient to maintain desire temperature in that portion, mostly without use of the primary heating/cooling system. Added secondary heating/cooling system, with thermal separation of sections, unable more rational use of a building during voluntarily energy conservation, by occupation of one section for primarily use, during different live stages such as; single individuals, young couples, couples after children start going to college.

### BRIEF DESCRIPTION OF THE DRAWINGS

Other objects and advantage of the present invention will become more apparent in accordance with the following specification and annexed drawings in which:

FIG. 1 is a schematic plan view of a living room, kitchen with dining room, bathroom and bedroom provided with additional heating assembly and separation of that portion of the building, according to the invention.

FIG. 2 is a schematic plan view of a lower floor of the building provided with separation of the upper floor and additional secondary heating assembly according to the invention.

### DETAILED DESCRIPTION OF THE INVENTION

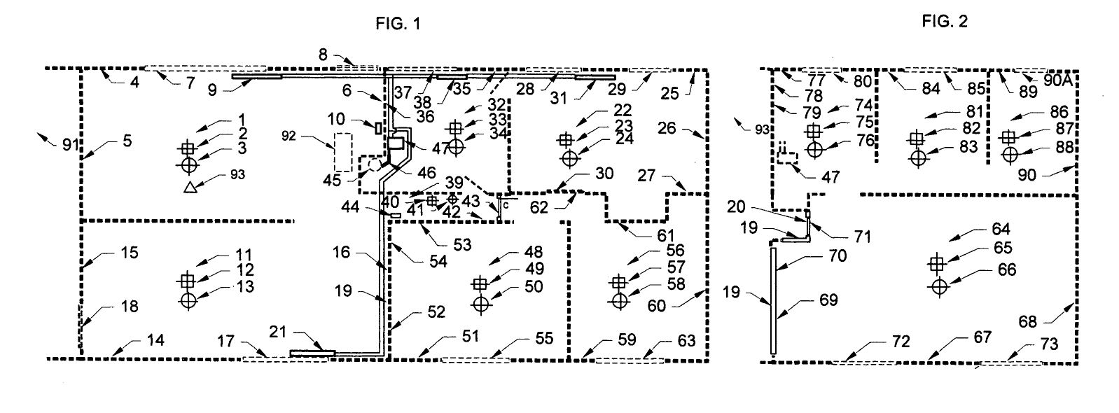

The present invention will be described by referring to the accompanying drawings that illustrate preferred embodiments of the invention. FIG. 1 is a schematic plan view of proposed or existing living room, kitchen with dining room, bedroom and bathroom with proposed additional heating assembly according to the invention. FIG. 2 is a schematic plan view of a proposed or existing lower floor of a building, with proposed additional heather according to the invention.

On FIG. 1, the proposed or existing living room 1 with ceiling 2,floor 3, exterior wall 4, wall 5 located along the garage 91, interior wall 6, exterior window 7, exterior door 8, shall be proposed to be heated with the radiator/heat register 9, which temperature will be regulated with the proposed programmable thermostat 10, during the time, when efficient energy use is required. The proposed or existing kitchen and dining room 11, with ceiling 12, floor 13, exterior wall 14, wall 15, facing garage 91, interior wall 16, exterior window 17, door 18 facing garage 91, interior wall 19 and door 20 as separations between two heating zones, shall be heated with radiator/heating register 21, during the energy critical time.

The proposed or existing bedroom 22, with ceiling 23, floor 24, exterior wall 25, exterior wall 26, interior wall 27, exterior windows 28 & 29, interior door 30, shall be heated with the proposed radiator/heat register 39, during the peak energy demand.

The proposed or existing bathroom 32, with ceiling 33, floor 34, exterior walls 35 & 36, exterior window 37, shall be heated with the proposed radiator/heat register 38, during the peak energy demand.

The proposed or existing hallo way 39, with ceiling 40, floor 41, interior wall 42 and interior door 43, shall be heated with the heat of the radiator/heat register 9 and radiator/heat register 21.

In FIG. 1 also are shown the bedroom 48 with ceiling 49, floor 50, exterior walls 51 & 52, interior wall 53 toward the hallo way 39, interior wall 54 toward the dining room 11, exterior window 55, then the bedroom 56 with ceiling 57, floor 58, exterior walls 59 & 60, interior wall 61 toward bedroom 22, interior door 62 toward bedroom 22, and exterior window 63, which bedrooms are located in to the other heating zone, which zone will be heated with the proposed/existing central furnace 92, with capacity to heat all building. In FIG. 2 are shown lower level recreation room 64, with ceiling 65, floor 66, exterior walls 67 & 68, interior wall 69, facing dining room 11, interior wall 70, facing crawl space 93, interior door 71, exterior windows 72 & 73, then utility room 74 with ceiling 75, floor 76, exterior wall 77, interior wall 78 facing lower level of the living room 1, Interior wall 79 facing crawl space 93, exterior window 80, proposed heater/furnace with accessory 47 with heat capacity calculated by any existing method or by my tables, submitted with my application Ser. No. 29/226,275 if approved, existing exhaust pipe45, new exhaust connection pipe 46 to the exhaust pipe 45, then lower level room 81 reserved for future thermal improvements, because of uncertainty with energy demand and supply, preferred to face south to south west, with ceiling 82, floor 83, exterior wall 84, exterior window 85, then lower level storage room 86, with ceiling 87, floor 88, exterior wall 89 & 90, exterior window 90A, all heated with the proposed or existing central heater (furnace) 92, during visiting of relatives, friends or having party when more floor area is needed.

1. I claim that my suggested secondary heating/cooling system, installed in one section of a new or existing building, with constructed thermal separation between the sections of any building, will unable temporally energy conservation, with sufficient living/working space for small family/group of people, during could or hot seasons.
